(19) United States
(12) Patent Application Publication
(10) Pub. No.: US 2009/0152345 A1
(43) Pub. Date: Jun. 18, 2009

(54) Methods and Apparatus for Automated Order Delivery in Customer Service Applications

(75) Inventor: Jennie Psihogios Johnson, Suwanee, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation, Dayton, OH (US)

(21) Appl. No.: 11/958,436

(22) Filed: Dec. 18, 2007

(51) Int. Cl. G06F 7/02

(52) U.S. Cl. 235/381

(57) ABSTRACT

Systems and techniques for automated partial order delivery. After a customer has entered a self service order and presented payment, the customer is able to present a receipt at an automated dispensing station. An automated dispensing mechanism retrieves order information associated with the receipt and allows dispensing of products, such as drink cups at a fast food restaurant, whose purchase is reflected in the order. Upon release of all the authorized products, authorization for dispensing of products is revoked. If a predetermined time passes after the last release, authorization is temporarily revoked, renewable upon subsequent presentation of the receipt, if products that have not yet been dispensed are reflected in the order.

### FIELD OF THE INVENTION

The present invention relates generally to improved customer service operations. More particularly, the invention relates to automated systems and techniques for automated delivery of goods upon submission of proof of payment or other indication that delivery is authorized.

### BACKGROUND OF THE INVENTION

Many retail operations are increasing the use of self service operations. Properly implemented, self service operations can both save labor costs and increase customer satisfaction by decreasing customers' waits in line. Fast food operations are increasingly implementing self service operations. In a fast food self service operation, a customer submits his or her order and submits payment. The customer's order is delivered to employees, and the employees prepare and assemble the food items and make delivery to the customer.

Traditional employee staffed fast food operations similarly accept an order from a customer and take payment, with food delivery to be made when the food is prepared, but the taking of the order and acceptance of payment is performed under employee control. However, when a customer orders a drink, the drink cup is frequently presented to the customer as soon as payment is tendered. The customer is then able to take the cup and dispense his or her own drink at a self service dispensing station.

However, in the case of self service operations, it has been difficult to allow the customer to receive the drink cup before the meal is delivered. Simply placing drink cups at the dispensing station allows the customer to take the cup and dispense the drink whether he or she has paid for a drink or not. Under an honor system, a customer might easily decide to order a meal without a drink, and simply take the cup from the station and dispense the drink.

Soft drinks are high margin items in fast food operations, and it is highly undesirable to allow customers to take drinks without paying. On the other hand, customers like to save time by being able to receive their drink without waiting for the rest of their orders, and they like to be able to consume a portion of the drink while waiting for their order to be assembled if they so desire.

### SUMMARY OF THE INVENTION

A system according to one aspect of the invention addresses such issues, as well as others, by providing for controlled automated dispensing of drink cups. A customer places his or her order and tenders payment, and is then delivered a receipt bearing a code, such as a bar code. The receipt may be the receipt for the order as a whole, or may be a special receipt indicating the purchase of a drink. When payment is tendered, dispensing of a drink is authorized, and the authorization is associated with the code appearing on the receipt. The receipt includes a bar code that can be scanned at a drink cup dispenser. A scanner at the drink cup dispenser reads the bar code, and determines whether the code authorizes dispensing of a cup, and, if so, what size cup is to be dispensed. The code may authorize multiple cups to be dispensed, as in the case of a family of four all ordering drinks. In this instance, as cups are dispensed, the number of cups authorized to be dispensed is reduced, so that a subsequent presentation of the bar code will not dispense further cups. Similarly, when an individual pays for one drink and dispenses a cup, the number of cups authorized to be dispensed is reduced to zero.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a fast food ordering system according to an aspect of the present invention; and

FIG. 2 illustrates a process of fast food ordering according to an aspect of the present invention.

### DETAILED DESCRIPTION

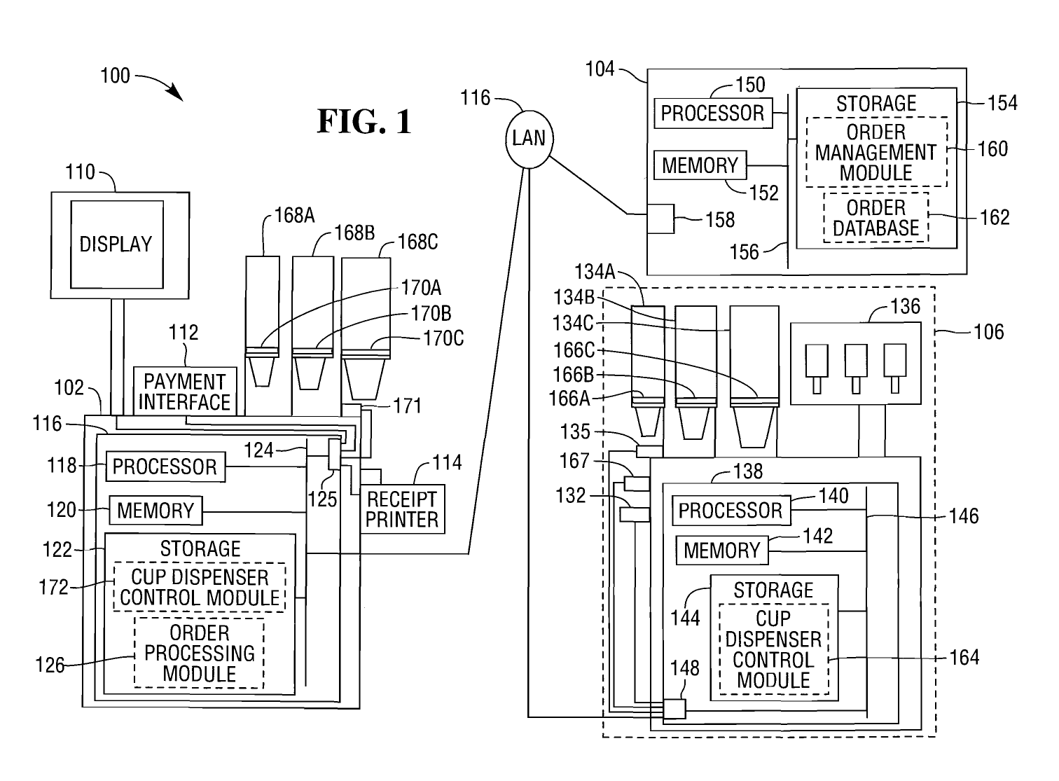

FIG. 1 illustrates a fast food ordering system according to an aspect of the present invention. The ordering system 100 suitably includes an order station 102, a server 104, and a drink dispensing station 106. In one embodiment of the invention, the order station 102 may be implemented as a self service kiosk. The order station 102 may suitably include a touch screen display 110, a payment interface 112, and a receipt printer 114. The station 102 also may suitably include a computer 116, including a processor 118, memory 120, and storage 122, all of which suitably communicate over a bus 124, which also allows communication with the display 110, the payment interface 112, and the receipt printer 114. The display 110, payment interface 112, and receipt printer 114 are suitably connected to the bus 124 through an interface 125.

The computer 116 may also implement an order processing module 126, comprising software hosted in storage 122 and delivered to the memory 120 as needed for execution by the processor 116. The exemplary order station 102 is presented here as a self service station, but it will be recognized that the order station 102 may be operated as an employee assisted station and that other self service stations and employee assisted stations may be employed without departing from the teachings of the present invention.

When a customer approaches and activates the station 102, the order processing module 126 presents an order display, allowing the customer to make selections as desired. When the customer indicates that he or she has finished making selections, a payment presentation display is presented and the customer is allowed to choose the method of payment and to tender payment. Once payment is received, a customer order file is created and transferred to the server 104. The customer order file is accessible to employees. The customer order file also includes a notation as to how many drinks, and what sizes of drinks, if any, have been ordered. Once payment has been presented and the order file created, the receipt printer prints a receipt. The customer is then able to take the receipt, which suitably includes a bar code. The bar code is suitably encoded with an order number associated with the customer order. A similar procedure can be followed if the station 102 or a similar station is operated by an employee, with the same or similar information being created and the receipt being printed in a similar way.

The customer is then able to take the receipt to the drink dispensing station 106. The drink dispensing station 106 includes a scanner 132, cup dispensers 134A-134C, a controller 135, and a drink dispenser 136. The station 106 also includes a computer 138, including a processor 140, memory 142, storage 144, bus 146, and control and communication interface 148. The control and communication interface 148 provides a connection for the scanner 132 and the controller 135 to the server 104. The server 104 includes a processor 150, memory 152, storage 154, bus 156, and external interface 158. The server 104 implements an order management module 160, hosted in storage 154, and an order database 162. The order database 162 includes an order file for each customer order, including a notation as to whether a drink is included in the order and, for each drink included, a notation as to whether a cup has already been dispensed.

When a customer takes the receipt to the drink dispensing station, he or she scans the receipt using the scanner 132. The scanner 132 decodes the bar code on the receipt and transfers the bar code information to the computer 138. A cup dispenser control module 164 is suitably hosted on the computer 138, suitably stored as software in storage 144 and transferred to memory 142 as needed for execution by the processor 142. The cup dispenser control module 164 uses the bar code information, which may typically include a unique receipt identifier, to look up corresponding receipt information stored in the order database 162. If the customer order includes one or more drink purchases, the cup dispenser control module 164 authorizes release of one cup for each drink purchase indicated in the order database.

The cup dispensers 134A-134C respond to commands given by the computer 138 under the control of the module 164 to release the authorized number of cups of the proper sizes. As each cup is dispensed, a notation is made in the customer's order for each cup that has been released. Each indication that a cup has been released reduces by one the number of cups that are authorized to be dispensed in response to presentation of the receipt.

The cup dispensers 134A-134C suitably include a counting mechanism for accounting for releases, such as optical or mechanical sensors 166A-166C. The cup dispenser control module 164 receives the count information from the sensors 166A-166C and associates the count information with the receipt that was scanned by the customer. The cup dispenser control module 164 then passes the count information to the order management module 160, which updates the order with the count information, so that the number of releases remaining to be authorized is reduced by the number of releases that has already occurred. If a customer does not take all desired cups at one time, a subsequent scan of the receipt will release additional cups, if a cup has not yet been released for every drink ordered.

As an alternative to printing receipt information to be used as an index to look up order information, the order management module 160 may suitably print a receipt code that can be used as an indicator as to how many cups are to be dispensed, and authorizing the dispensing of cups. Presentation of the receipt may authorize the dispensing of the specified number of cups, with the number authorized being decreased with every cup dispensed. The drink dispensing station 106 may then manage the dispensing of cups without a need to communicate with the server 104.

It will be recognized that as an alternative or in addition to using a scanner such as the scanner 132 to read a receipt printed by a receipt printer, the station 106 may suitably include alternative reading devices, of which an example might be a radio frequency identification (RFID) device reader 167. The customer might be provided with an REID device, which may be suitably embedded in a loyalty program card. Information could be read from the card and used to authorize cup delivery, for example, when a customer had accumulated an expenditure amount that entitled him to one or more free drinks. An alternative an REID device reader would 167 would be to read an RFID device embedded in a promotional mailer. The device, when presented, could authorize the delivery of cups, for example, by being encoded with a direct authorization to dispense a specified number of cups.

In addition or as an alternative to providing the cups at a centralized dispensing station such as the station 106, cups may be dispensed at a variety of additional or alternative locations. For example, cup dispensers 168A, 168B and 168C, utilizing sensors 170A, 170B, and 170C, and controller 171, may be mounted at the order station 102, with the controller 171 being connected to the bus 124 through the interface 125. In such a case, a scanner would not typically be needed because the cups could be dispensed upon entry of the order. As another example, cup dispensers could be placed at dining tables, or at kiosks placed at appropriate locations in a facility.

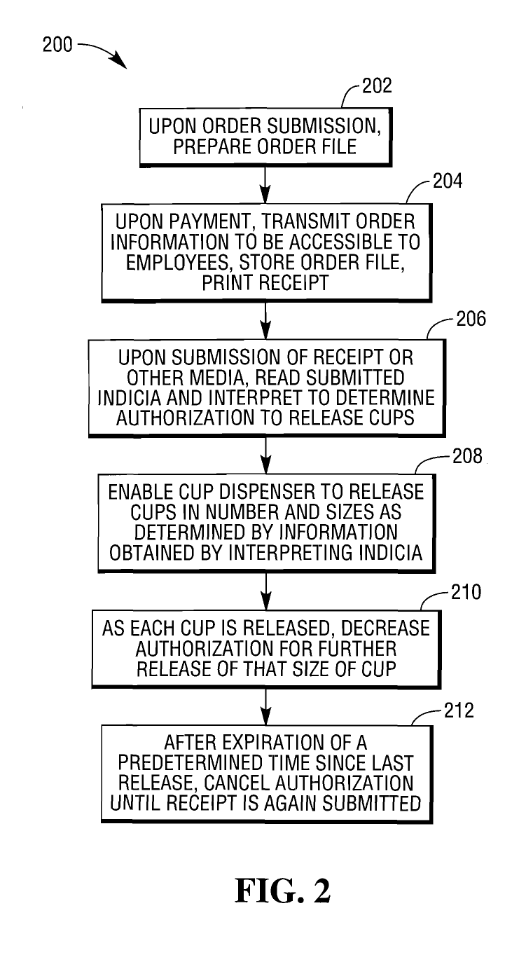

FIG. 2 illustrates the steps of a process 200 according to an aspect of the present invention, which may suitably be carried out using a system similar to the system 100 of FIG. 1. At step 202, upon receipt of fast food order information from a customer at a self service order submission station, an order file is prepared. The order file suitably includes indications as to how many and what size drinks were ordered by the customer. At step 204, upon payment by the customer, order information from the order file is transmitted so as to be accessible to employees responsible for fulfilling the order, and the order file is stored at a central repository accessible to data processing devices, and a receipt is printed, bearing indicia, such as a bar code. The indicia may suitably associate the receipt with the order file, but indicia may be prepared and placed on the receipt or other media so as to provide an independent delivery authorization, such as a readable validation code and information indicating the number of cups to be released.

At step 206, upon submission of the receipt or other media by a customer at a drink dispensing station, such as by scanning a bar code on the receipt using a scanner at the drink dispensing station, or reading an RFID device at an RFID reader, the indicia appearing on the receipt or other media is read and interpreted, for example, reading an index to an order file to retrieve the order file associated with the receipt, or reading a release authorization. At step 208, a cup dispenser associated with the drink dispensing station is enabled to release cups in the number and sizes authorized by the information obtained by interpreting the indicia. At step 210, as each cup is released, the number of cups of that size remaining to be released is decreased by one, until all cups indicated in the order file have been released. At step 212, if a specified time period passes since the last cup is released, the authorization for the cup dispenser to release cups expires, but the dispenser can be again enabled to release the remaining cups by once again submitting the receipt.

The customer is thus made able to release the number of cups desired at a particular time, such as before receiving the food order, while retaining the ability to release additional cups at a later time, such as after receiving the food order. As an example, in many families with children, each child may wish to be responsible for obtaining his or her own drink, and parents may wish to send children to the drink dispenser one at a time to prevent horseplay, or the like. In another scenario, one member of a party may wish to obtain his or her own drink upon ordering, while another may wish to obtain it after the food has been delivered. It will also be recognized that

While the present invention is disclosed in the context of a presently preferred embodiment, it will be recognized that a wide variety of implementations may be employed by persons of ordinary skill in the art consistent with the above discussion and the claims which follow below.

I claim:

1. A system for partial order delivery, comprising:
a reader for receiving an identifier associated with a customer order;
an automated dispenser; and
a control mechanism for using the identifier to retrieve customer order information and to direct the automated dispenser to allow dispensing of products of the size and number purchased by the customer as reflected in the order.

2. The system of claim 1, wherein the reader is a bar code scanner and the information is a bar code associated with a customer order number;

3. The system of claim 1, wherein the control mechanism uses the identifier to retrieve customer order information stored in a customer order file on a remote servers the customer order file reflecting entry of a self service order by the customer.

4. The system of claim 3, wherein the control mechanism counts each product as it is dispensed and, as each product is dispensed, updates the customer order file to reduce the number of products that remain authorized to be dispensed.

5. The system of claim 4, wherein the control mechanism revokes the authorization to dispense products when the number of products remaining authorized to be dispensed is reduced to zero.

6. The system of claim 4, wherein the control mechanism revokes the authorization to dispense products when a predetermined time has elapsed since the last product was dispensed, and wherein the control mechanism renews the authorization when the identifier is presented alter revocation, provided that the number of products remaining authorized to be dispensed is greater than zero.

7. A method of partial order delivery, comprising the steps of:
receiving an identifier;
retrieving customer order information associated with the identifier;
controlling an automated dispenser so as to release products of the size and number purchased by the customer as reflected in the order.

8. The method of claim 7, wherein the step of receiving the identifier includes reading a bar code representing an encoded receipt number.

9. The method of claim 7, wherein the step of retrieving the customer order information includes retrieving a customer order file stored on a remote server, the customer order file reflecting a self service order entered by the customer.

10. The method of claim 7, wherein the step of releasing products includes counting each product as it is dispensed and, as each product is dispensed, updating the customer order file to reduce the number of products that remain authorized to be dispensed.

11. The method of claim 10, further comprising a step of revoking the authorization to dispense products when the number of products remaining authorized to be dispensed is reduced to zero.

12. The method of claim 11, further comprising a step of revoking the authorization to dispense products when a predetermined time has elapsed since the last product was dispensed, and wherein the control mechanism renews the authorization when the identifier is presented after revocation, provided that the number of products remaining authorized to be dispensed is greater than zero.

13. A method of product delivery, comprising the steps of:
reading encoded information on a medium submitted by a customer and interpreting the encoded information so as to determine whether dispensing of beverage cups is authorized and to determine the size and number of cups authorized to be dispensed; and
controlling an automated dispenser so as to release the size and number of cups authorized.

14. The method of claim 13, wherein the encoded information includes validating information and information indicating the size and number of cups to be dispensed.

15. The method of claim 14, wherein reading the encoded information includes reading a bar code.

16. The method of claim 14, wherein reading the encoded information includes reading an RFID device.

17. The method of claim 13, wherein the encoded information includes information indicating that a customer account associated with the device indicates an expenditure level entitling the customer to a specified number of free beverages.

18. The method of claim 15, wherein the validating information includes a validation code for a free beverage promotion.

19. The method of claim 13, wherein interpreting the encoded information includes retrieving stored customer order information associated with the encoded information and examining the order information to determine how many beverages have been ordered by the customer.

20. The method of claim 19, wherein examining the order information includes examining updates to the order information to determine how many cups have already been dispensed.
